(19) United States
(12) Patent Application Publication
(10) Pub. No.: US 2017/0297493 A1
(43) Pub. Date: Oct. 19, 2017

(54) SYSTEM AND METHOD TO IMPROVE SITUATIONAL AWARENESS WHILE OPERATING A MOTOR VEHICLE

(71) Applicant: FORD GLOBAL TECHNOLOGIES, LLC, Dearborn, MI (US)

(72) Inventor: Brian Gillespey, Gregory, MI (US)

(21) Appl. No.: 15/130,446

(22) Filed: Apr. 15, 2016

(51) Int. Cl. B60R 1/08; H04N 5/247

(52) U.S. Cl. CPC B60R 1/08; H04N 5/247; B60R 2300/105; B60R 2300/8026

(57) ABSTRACT

A situational awareness system is provided for a motor vehicle. That situational awareness system includes a rear view mirror having a right side section, a left side section and a center section. In addition, the situational awareness system includes: an imaging system including a right side camera, a left side camera and a center rear camera and a display system including a right side display, a left side display and a center rear display. Still further, the situational awareness system includes a control module configured to activate the imaging system and the display system to project images through the various sections of the rear view mirror.

### TECHNICAL FIELD

This document relates generally to the motor vehicle equipment field and, more particularly, to a system and method for improving the situational awareness of an operator of a motor vehicle.

### BACKGROUND

One of the most important ways for enhancing driver safety is minimizing blind spots. When changing lanes a driver must be sure there is proper clearance with other vehicles by checking the side view mirror. If the side view mirror is not properly adjusted, a blind spot can be created. This improper mirror adjustment can give the driver an appearance of proper clearance to change lanes when in actuality there is an obstruction such as another vehicle. If another vehicle or obstruction is present and a lane change maneuver is attempted, it can lead to a near miss or a collision.

This document relates to a new and improved system and method for improving the situational awareness of an operator of a motor vehicle and thereby promoting safer vehicle operation.

### SUMMARY

In accordance with the purposes and benefits described herein, a situational awareness system is provided for a motor vehicle. That situational awareness system comprises (a) a rear view mirror including a right side section, a left side section and a center section, (b) an imaging system including a right side camera, a left side camera and a center rear camera, (c) a display system including a right side display, a left side display and a center rear display and (d) a control module. That control module is configured to selectively activate (a) the right side display to project an image from the right side camera through the right side section of the rear view mirror, (2) the left side display to project an image from the left side camera through the left side of the rear view mirror and (3) the center rear display to project an image from the center rear camera through the center section of the rear view mirror.

The situational awareness system may further include a right side blind spot warning element and a left side blind spot warning element. In one possible embodiment, the right side blind spot warning element comprises a right side portion of a rim of the rear view mirror that illuminates. The left side blind spot warning element comprises a left side portion of the rim of the rear view mirror that illuminates.

The control module may be further configured to automatically activate the right side camera and the right side display when an operator of the motor vehicle initiates a right turn signal. Similarly, the control module may be further configured to automatically activate the left side camera and the left side display when the operator of the motor vehicle initiates a left turn signal.

Still further, the control module may be further configured to activate the right side camera, the right side display, the left side camera, the left side display, the center rear camera and the center rear display when the operator of the motor vehicle places a transmission of the motor vehicle in reverse in preparation for backing the motor vehicle.

In accordance with an additional aspect, a method is provided for improving the situational awareness of an operator of a motor vehicle. That method may be described as comprising the steps of: (a) monitoring, by an imaging system, a first area on a right side of the motor vehicle, a second area behind the motor vehicle and a third area on the left side of the motor vehicle and (b) selectively projecting, by a display system, a first image of the first area through a right side section of a rear view mirror, a second image of the second area through a center section of the rear view mirror and a third image of the third area through a left side section of the rear view mirror.

The method may further include the step of activating, by a control module, the imaging system and the display system. Still further, the method may include the step of providing a blind spot warning. Thus, in some embodiments the method may include the step of illuminating a right rim portion of the rear view mirror when an object is detected in the first area on the right side of the vehicle. Similarly, the method may include the step of illuminating a left rim portion of the rear view mirror when an object is detected in the third area on the left side of the vehicle.

In addition, the method may include the step of automatically activating, by the control module, the imaging system and the display system when the operator of the motor vehicle initiates a turn signal. Thus, the method may include imaging the first area on the right side of the motor vehicle and projecting a first image of the first area through the right side section of the rear view mirror when the operator initiates a right turn signal. Similarly, the method may include the step of imaging the third area on the left side of the motor vehicle and projecting a third image of the third area through the left side section of the rear view mirror when the operator initiates a left turn signal.

Still further, the method may include the steps of (a) activating the imaging system, by a control module, and imaging, by the imaging system, the first area, the second area and the third area, (b) activating the display system, by the control module, and projecting, by the display system, the first image through the right side section of the rear view mirror, the second image through the center section of the rear view mirror and the third image through the left side section of the rear view mirror when the operator places the transmission of the motor vehicle in reverse.

In the following description, there are shown and described several preferred embodiments of the situational awareness system. As it should be realized, the situational awareness system and the related method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the situational awareness system and together with the description serve to explain certain principles thereof. In the drawing figures:

FIG. 1 is a schematic block diagram of the situational awareness system.

FIG. 2 is a top plane view of a motor vehicle showing one possible embodiment for positioning the right side camera, left side camera and center rear camera of the imaging system.

FIG. 3 is a front elevational view of the rear view mirror of the system in the deactivated state.

FIGS. 3a-3f illustrate the rear view mirror in various other operating states that are described in detail in the following section of this document.

FIG. 4 is a schematic cross-sectional view of the rear view mirror illustrating the construction thereof including the positioning of the right side display, center rear display and left side display of the display system behind the two-way glass face of the rear view mirror.

Reference will now be made in detail to the present preferred embodiments of the situational awareness system, examples of which are illustrated in the accompanying drawing figures.

### DETAILED DESCRIPTION

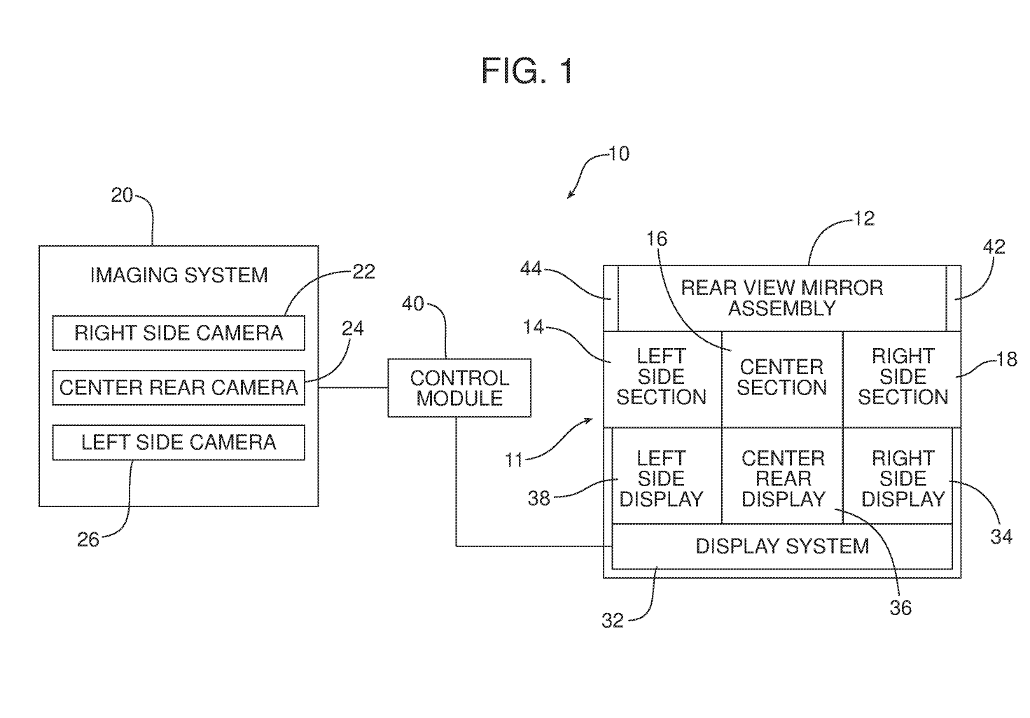

Reference is now made to FIG. 1 illustrating the situational awareness system 10 that is specifically adapted to enhance the situational awareness of an operator of a motor vehicle. That situational awareness system 10 includes a rear view mirror 12 having a left side section 14, a center section 16 and a right side section 18. As will be apparent in the following description, the rear view mirror 12, including the sections 14, 16, 18, is made from a two-way glass which functions in a normal operating mode as a standard rear view mirror providing a reflective image. However, when the situational awareness system 10 is activated, an image may be projected through the various sections 14, 16, 18 of the rear view mirror 12 toward the driver of the motor vehicle 28.

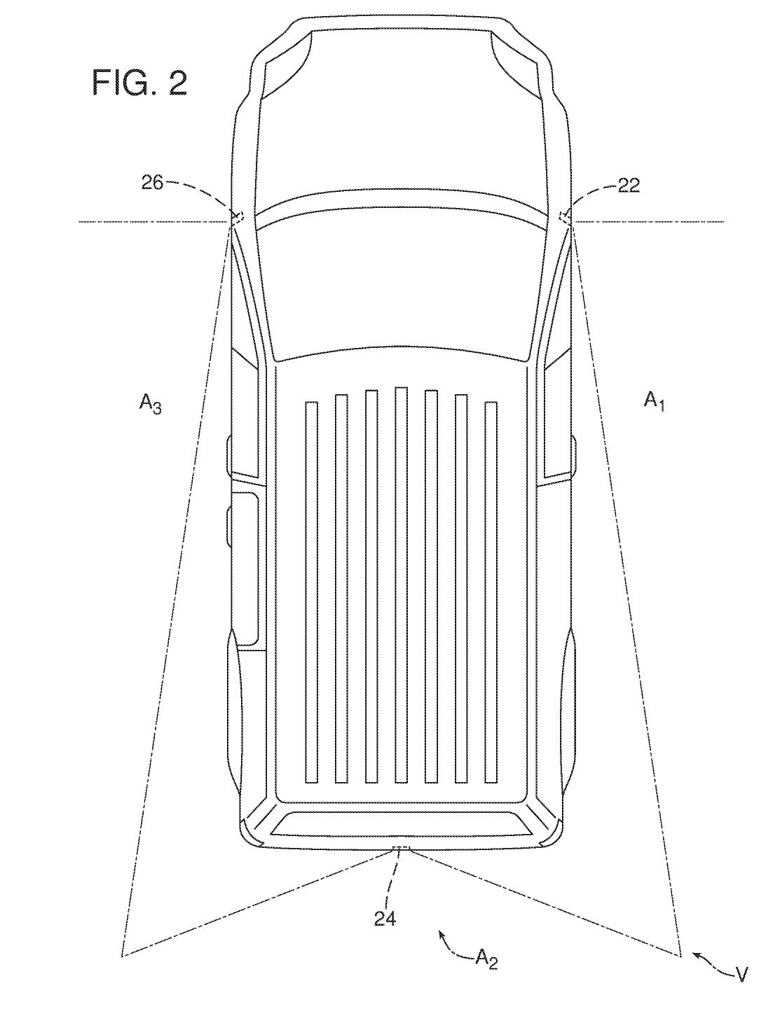

The situational awareness system 10 also includes an imaging system 20 including a right side camera 22, a center rear camera 24 and a left side camera 26. As illustrated in FIG. 2, the right side camera 22 may be mounted to the motor vehicle 28 anywhere along the right side of the motor vehicle 28 such as about the midpoint. Similarly, the left side camera 26 may be mounted anywhere along the left side of the motor vehicle 28 such as around the midpoint. The center rear camera 24 may be mounted at the rear of the motor vehicle 28 such as at the center of the trunk 30. Each of the cameras 22, 24, 26 may be wide angle cameras which may be oriented to provide a continuous and uninterrupted field of view V around the motor vehicle 28. More specifically, the right side camera 22 may provide a first area of view A1, the center rear camera may provide a second area of view A2 and the left side camera 26 may provide a third area of view A3.

Referring back to FIG. 1 and to FIG. 4, the situational awareness system 10 also includes a display system 32 including a right side display 34, a center rear display 36 and a left side display 38. As should be appreciated, the display system 34 is provided in the rear view mirror 12 with the right side display 34 located behind the right side section 18, the center rear display 36 located behind the center section 16 and the left side display 38 located behind the left side section 14. Screen dividers 39 between the displays 34, 36, 38 ensure that the normal reflective state of any mirror section 14, 16, 18 is maintained unless the display 38, 36, 34 behind that specific mirror section is activated.

The situational awareness system 10 may also include a control module 40 comprising, for example, a computing device such as a dedicated microprocessor or electronic control unit (ECU) operating in accordance with instructions from appropriate control software. Thus, the control module 40 may comprise one or more processors, one or more memories and one or more network interfaces communicating with each other over a communication bus. If desired, the control module 40 may be connected with a body control module or BCM (not shown). Such a BCM is known to comprise a computing device having one or more processors, one or more memories and one or more network interfaces, a human interface, a GPS/geolocator component, a display device such as a multi-function display with touch screen capability and a speech processor that all communicate with each other over a communication bus. Such a BCM performs a number of interior body electrically based functions including, for example, interior locking, remote key entry, interior light, exterior light, windshield wiper control and the like. In some embodiments the BCM may also function to control entertainment functions (e.g. radio, CD player and communications such as telephone and internet communications over a wireless network). In some embodiments the BCM is connected by a communication bus to other control modules that provide one or more of these additional functions.

As will be appreciated from the following description, the control module 40 of the situational awareness system 10 is configured to selectively activate (a) the right side display 34 to project an image from the right side camera 22 through the right side section 18 of the rear view mirror 11, (b) the left side display 38 to project an image from the left side camera 26 through the left side section 14 of the rear view mirror and (c) the center rear display 36 to project an image from the center rear camera 24 through the center section 16 of the rear view mirror.

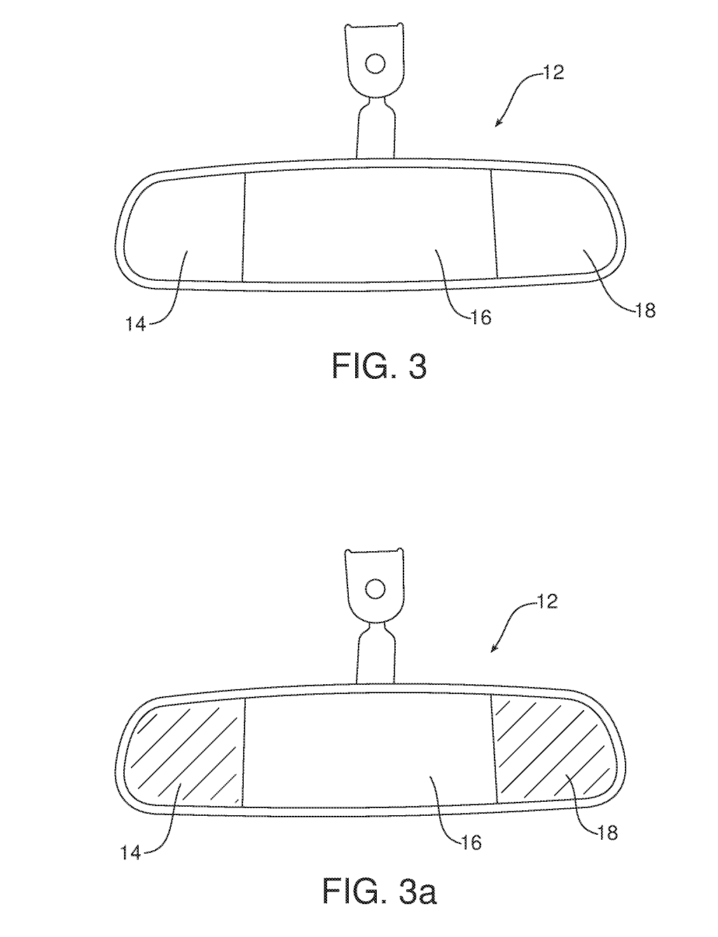

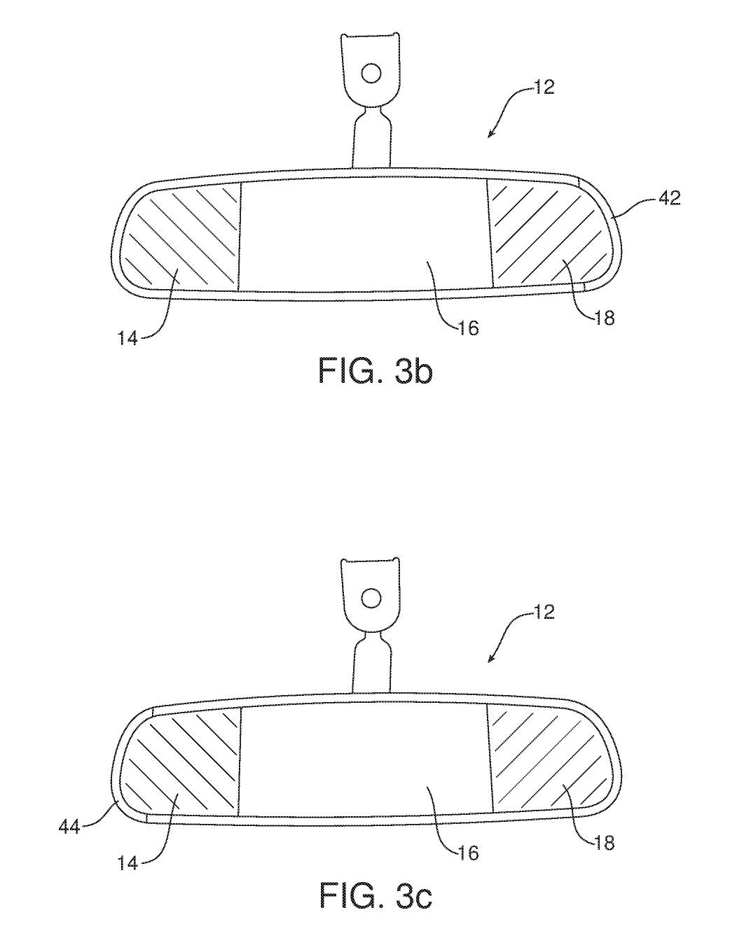

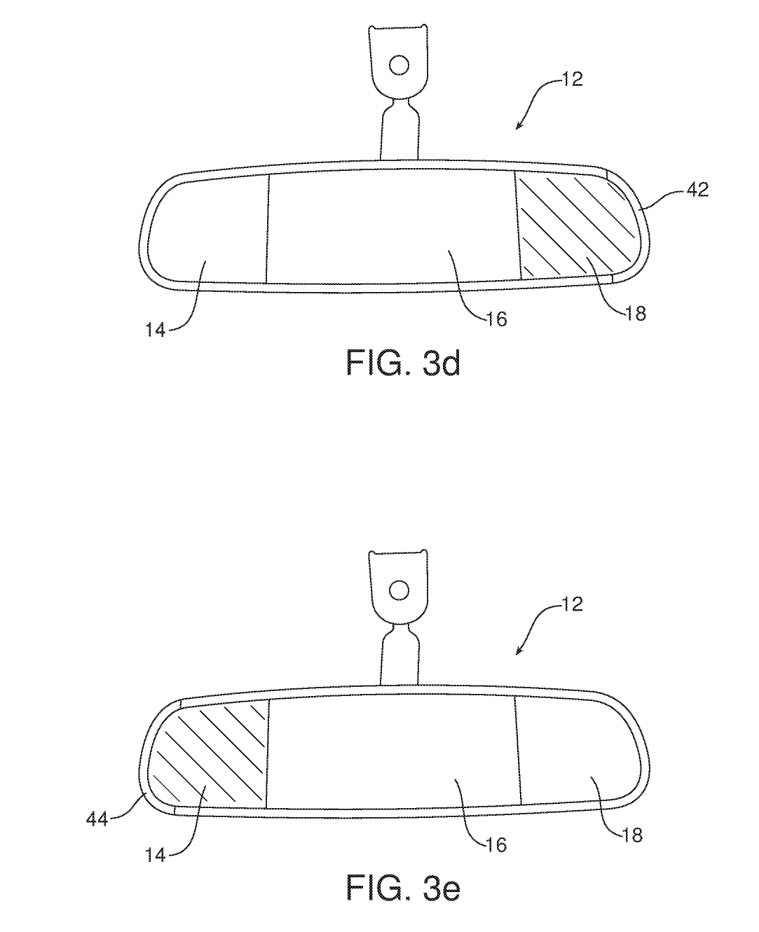

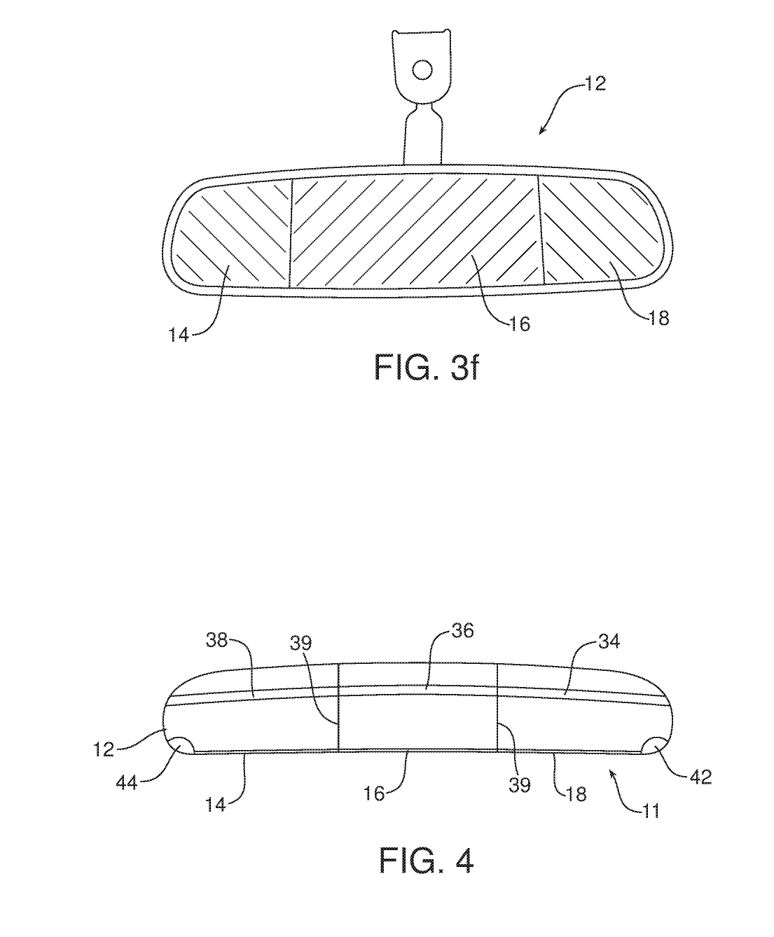

When the situational awareness system 10 is switched off or inactive, the left side section 14, the center section 16 and the right side section 18 of the rear view mirror 12 function as a standard rear view mirror providing a complete mirror image for the driver of the motor vehicle through the rear window (see FIG. 3).

In the event the vehicle operator selects by voice activation, mechanical actuator or touch screen display constant side view activation mode, the control module 40 activates the left and right side cameras 22, 26 and the left and right side displays 34, 38 so that a video image of area of view A1 is captured by the right side camera 22 and projected by the right side display 34 through the right side section 18 of the rear view mirror 12 and a video image of the area of view A3 is captured by the left side camera 26 and projected by the left side display 38 through the left side section 14 of the rear view mirror while the center section 16 of the mirror remains in a deactivated state so as to provide a reflective image of the area of view A2 behind the motor vehicle. See FIG. 3a.

The vehicle operator may also select, by voice activation or other means full activation mode whereby the control module 40 activates the left side, right side and center rear cameras 22, 24, 26 so that: (1) a video image of area of view A1 is captured by the right side camera 22 and projected by the right side display 34 through the mirror section 18, (2) a video image of area of view A3 is captured by the left side camera 26 and projected by the left side display 38 through the mirror section 14 and (3) a video image of area of view A2 is captured by the center rear camera 24 and projected by the center rear display 36 through the mirror section 16. Thus, full video camera viewing on the rear view mirror 12 is possible at all times if desired.

The situational awareness system 10 may further include a blind spot warning system including a right side blind spot warning element 42 and a left side blind spot warning element 44. As illustrated in FIG. 3b, the right side blind spot warning element 42 may comprise a portion of the rim of the rear view mirror assembly 12 that may be illuminated in an attention attracting color such as yellow. In contrast, as illustrated in FIG. 3c, the left side blind spot warning element 44 may comprise a portion of the rim of the rear view mirror assembly 12 at the left edge of the mirror which may be illuminated in an attention grabbing color such as yellow whenever an object is detected to the left of the vehicle.

The control module 40 may also be configured to automatically activate the right side camera 24 and the right side display 34 when the operator of the motor vehicle initiates a right turn signal by manipulating the turn signal stalk (not shown). As illustrated in FIG. 3d, when in this activation mode, the video image of area of view A1 is captured by the right side camera 22 and projected by the right side display 34 through the right side section 18 of the rear view mirror 12 while the remaining sections 14, 16 of the rear view mirror remain in the deactivated or reflective state. If an obstruction is detected in the area of view A1 and the situational awareness system 10 includes blind spot warning capability that is activated for operation, the right side blind spot warning element 42 is also illuminated. Similarly, the control module 40 may be further configured to automatically activate the left side camera 26 and the left side display 38 when the operator of the motor vehicle initiates a left turn signal by manipulating the turn signal stalk. In this situation, a video image of the area of view A3 is captured by the left side camera 26 and projected by the left side display 38 through the left side section 14 of the rear view mirror 12 while the remaining sections 16 and 18 remain in the inactivated, reflective state. Again, if the situational awareness system 10 is equipped with blind spot warning capability that is activated for operation, the left side blind spot warning element 44 will be illuminated if an object is detected in the area of view A3.

Still further, the control module 40 may be further configured to activate the right side camera 22 and the right side display 34, the left side camera 26 and the left side display 38 and the center rear camera 24 and the center rear display 36 when the operator of the motor vehicle places a transmission of the motor vehicle in reverse indicating a desire to back the motor vehicle. Thus, in this situation: (a) a video of the area of view A1 captured by the right side camera 22 is projected by the right side display 34 through the right side section 18 of the mirror 12 while (b) a video of the area of view A2 captured by the center rear camera 24 is projected by the center rear display 36 through the center section 16 of the rear view mirror and (c) a video of the area of view A3 captured by the left side camera 26 is projected by the left side display 38 through the left side section 14 of the rear view mirror. As a result, video images of the complete field of view V are provided to the operator of the motor vehicle 28 at the standard rear view mirror location where the operator is conditioned to receive this information. Advantageously, the imaging system 20 and display system 32 provide a complete field of view image without blind spots so that the operator may more safely and confidently back the motor vehicle to a desired location. This is true even in low light conditions. In fact, the situational awareness system is so effective it eliminates the need for exterior rear view mirrors on a motor vehicle. Thus, the exterior rear view mirrors may be deleted to increase the aerodynamic efficiency and fuel economy of the motor vehicle 28 if desired.

Consistent with the foregoing description, a method is provided for improving the situational awareness of an operator of a motor vehicle. That method comprises the steps of monitoring, by an imaging system 20, a first area A1 on a right side of the motor vehicle, a second area A2 at a center or behind the motor vehicle and a third area A3 on a left side of the motor vehicle and selectively projecting, by a display system 32, a first image of the first area through a right side section 18 of a rear view mirror 12, a second image of the second area through a center section 16 of the rear view mirror and a third image of the third area through a left side section 14 of the rear view mirror.

The method may also include activating, by a control module 40, the imaging system 20 and the display system 32. Further, the method may include providing a blind spot warning. This may be done by illuminating a right rim portion 42 of the rear view mirror 12 when an object is detected in the first area A1 and/or illuminating a left rim portion 44 of the rear view mirror when an object is detected in the third area A3.

Still further, the method may include automatically activating, by the control module 40, the imaging system 20 and the display the system 32 when the operator of the motor vehicle initiates a turn signal. Accordingly, the method may include imaging the first area A1 on the right side of the motor vehicle and projecting a first image of the first area through the right side section 18 of the rear view mirror 11 when the operator initiates a right turn signal. Similarly, the method may include the step of imaging the third area on the left side of the motor vehicle and projecting a third image of the third area through the left side section 14 of the rear view mirror 12 when the operator initiates a left turn signal.

Still further, the method may include the steps of (a) activating the imaging system 20, by the control module 40, and imaging the first area A1, the second area A2 and the third area A3, (b) activating the display system 32, by the control module 40, and projecting the first image through the right side section 18 of the rear view mirror 12, the second image through the center section 16 of the rear view mirror and the third image through the left side section 14 of the rear view mirror when the operator places the transmission of the motor vehicle in reverse.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A situational awareness system for a motor vehicle, comprising:
a rear view mirror including a right side section, a left side section and a center section;
an imaging system including a right side camera, a left side camera and a center rear camera;
a display system including a right side display, a left side display and a center rear display; and
a control module configured to selectively activate (a) said right side display to project an image from said right side camera through said right side section of said rear view mirror, (b) said left side display to project an image from said left side camera through said left side section of said rear view mirror and (c) said center rear display to project an image from said center rear camera through said center section of said rear view mirror.

2. The situational awareness system of claim 1, further including a right side blind spot warning element and a left side blind spot warning element.

3. The situational awareness system of claim 2, wherein said right side blind spot warning element comprises a right side portion of a rim of said rear view mirror that illuminates.

4. The situational awareness system of claim 3, wherein said left side blind spot warning element comprises a left side portion of said rim of said rear view mirror that illuminates.

5. The situational awareness system of claim 1, wherein said control module is further configured to automatically activate said right side camera and said right side display when an operator of said motor vehicle initiates a right turn signal.

6. The situational awareness system of claim 5, wherein said control module is further configured to automatically activate said left side camera and said left side display when said operator of said motor vehicle initiates a left turn signal.

7. The situational awareness system of claim 6, wherein said control module is further configured to activate said right side camera and said right side display, said left side camera and said left side display and said center rear camera and said center rear display when the operator of the motor vehicle places a transmission of said motor vehicle in reverse.

8. A method for improving situational awareness for an operator of a motor vehicle, comprising:
monitoring, by an imaging system, a first area on a right side of said motor vehicle, a second area behind said motor vehicle and a third area on a left side of said motor vehicle; and
selectively projecting, by a display system, a first image of said first area through a right side section of a rear view mirror, a second image of said second area through a center section of said rear view mirror and a third image of said third area through a left side section of said rear view mirror.

9. The method of claim 8, further including activating by a control module, said imaging system and said display system.

10. The method of claim 9, including providing a blind spot warning.

11. The method of claim 10, including illuminating a right rim portion of said rear view mirror when an object is detected in said first area.

12. The method of claim 11, including illuminating a left rim portion of said rear view mirror when an object is detected in said third area.

13. The method of claim 12, including automatically activating by said control module, said imaging system and said display system when said operator of said motor vehicle initiates a turn signal.

14. The method of claim 13, including imaging said first area on said right side of said motor vehicle and projecting said first image of said first area through said right side section of said rear view mirror when said operator initiates a right turn signal.

15. The method of claim 14, including imaging said third area on said left side of said motor vehicle and projecting said third image of said third area through said left side section of said rear view mirror when said operator initiates a left turn signal.

16. The method of claim 15, including (a) activating said imaging system, by said control module, and imaging said first area, said second area and said third area, (b) activating said display system by said control module and projecting, by said display system, said first image through said right side section of said rear view mirror, said second image through said center section of said rear view mirror and said third image through said left side section of said rear view mirror when said operator places a transmission of said motor vehicle in reverse.

17. The method of claim 8, including automatically activating, by said control module, said imaging system and said display system when said operator of said motor vehicle initiates a turn signal.

18. The method of claim 17, including imaging said first area on said right side of said motor vehicle and projecting said first image of said first area through said right side section of said rear view mirror when said operator initiates a right turn signal.

19. The method of claim 18, including imaging said third area on said left side of said motor vehicle and projecting said third image of said third area through said left side section of said rear view mirror when said operator initiates a left turn signal.

20. The method of claim 8, including (a) activating said imaging system, by said control module, and imaging said first area, said second area and said third area, (b) activating said display system by said control module and projecting, by said display system, said first image through said right side section of said rear view mirror, said second image through said center section of said rear view mirror and said third image through said left side section of said rear view mirror when said operator places a transmission of said motor vehicle in reverse.
